(19) United States
(12) Patent Application Publication
(10) Pub. No.: US 2019/0016268 A1
(43) Pub. Date: Jan. 17, 2019

(54) FIXTURE FOR SECURING OBJECTS IN A TRUNK OF A PASSENGER CAR

(71) Applicant: GM GLOBAL TECHNOLOGY OPERATIONS LLC, Detroit, MI (US)

(72) Inventor: Marten Wittorf, Ingelheim (DE)

(73) Assignee: GM GLOBAL TECHNOLOGY OPERATIONS LLC, Detroit, MI (US)

(21) Appl. No.: 16/034,728

(22) Filed: Jul. 13, 2018

(30) Foreign Application Priority Data
Jul. 13, 2017 (DE) 102017006650.7

(51) Int. Cl. B60R 7/00; B60R 7/02

(52) U.S. Cl. CPC B60R 7/005; B60R 7/02

(57) ABSTRACT

A fixture is configured to secure objects in a trunk of a passenger vehicle. The fixture includes a frame, a net mounted in and held flat by the frame. A mount is configured to secure the frame to a structure of the passenger vehicle such as the loading floor in the trunk of the vehicle. The fixture may be positionable between a vertical or upright position in which the fixture extends away from the structure and a horizontal or prone position in which the fixture lays down on top of the structure.

### CROSS-REFERENCE TO RELATED APPLICATION

This application claims priority to German Patent Application No. 102017006650.7, filed Jul. 13, 2017, which is incorporated herein by reference in its entirety.

### TECHNICAL FIELD

The present disclosure relates to a fixture for securing objects in a trunk of a vehicle such as a passenger car.

### BACKGROUND

In passenger car, in particular those configured as a station wagon, the most varied of objects are transported in the trunk. Efforts are made to position the respective object securely in the trunk. It must further be ensured that objects transported in the trunk will not inadvertently fall out of the trunk area when the trunk lid is open.

Accordingly, there is a need in the art to provide a fixture for securing objects in a trunk of a passenger car, which is structurally especially simple in design, and can be readily installed in the vehicle, or the vehicle can be readily retrofitted with such a fixture.

### SUMMARY

In accordance with the present disclosure, the fixture for securing objects in a trunk of a passenger car includes a frame, a net mounted in the frame and flatly held by the frame, and a fastening fixture for mounting the frame in a structure of the passenger. Such a fastening fixture can be connected with the automobile structure by a fixture mount or simply mount, whether as part of the original equipment of the passenger car or within the framework of a retrofit. The mounts also preferably make it possible to disassemble the fixture when it is not needed. The frame includes a stable bearing element for flatly holding the net. The frame and net establish a boundary in the trunk, so that objects inside of the trunk can be securely accommodated.

For example, if the passenger car is a station wagon, the fixture is secured in the area of the end of the trunk facing the tailgate. This prevents the respective object from inadvertently getting out of the trunk. The fixture advantageously provides a retrofitable safeguard against objects falling out of the trunk.

The frame is preferably U-shaped or rectangular in design. In particular, the frame is configured as a flatly configured U or a flatly configured rectangle. On the one hand, this configuration makes it possible to keep the material outlay for the frame low including in particular aspects relating to weight. Furthermore, this ensures that the net will take up an especially large area, yielding a net with a relatively large mesh size that can be seen through, so that objects lying in front of the net are visible.

In particular, the frame extends over a length that essentially corresponds to the width of the trunk. This is understood in particular as a length that is slightly smaller than the width of the trunk. If the fixture is placed in the area of the rear end of the trunk, in particular in the area of a rear end of a trunk in a station wagon, this ensures that no objects can fall out of the trunk.

It is viewed as advantageous that the dimensions of the net correspond to those dimensions formed between frame sections. The net thus occupies the clear space between the frame sections. Overall, the arrangement including the frames and the net thus represents an essentially flat component, which is connected with the structure of the passenger car by the mounts.

In particular, the net is rectangular in design. As a result, it can cover a large surface, in particular one extending upwardly from the trunk floor to a point above the trunk floor that ensures the purpose of the present disclosure, which is to prevent objects from falling out of the trunk.

The net is preferably connected with the frame in the area of its contour sections facing the frame. This connection cannot be interrupted, and thus extends over the entire length of the net corners, which are allocated to frame sections. However, it is indeed also possible that the net be connected with the frame via a plurality of net binding points spaced apart from each other. This also ensures that an object cannot pass the surface between the frame sections, since the net is situated between the frame sections.

The mounts for securing the frame in the structure of the passenger car can have the most varied of designs. For example, one embodiment of a mount may include clamps, which serve to connect the frame and structure. On the other hand, the mount can be configured as a hinged connector making it possible to not only connect the frame and structure, but also to pivot the frame relative to the structure. As a result, the frame can be pivoted from a vertical or upright position into a horizontal or prone position. In the prone position, the frame rests on a trunk floor with the net stretching over the trunk floor. In the upright position, the frame and net extend from and project over the trunk floor.

For example, the mounts may include Velcro strips or carpet strips connectable or connected with the structure of the passenger car with the mounts surrounding the frame in partial areas. In this configuration, the mounts have a very simple structural configuration, and may be formed by a special configuration of the carpet already present in the passenger car or as separate mounts.

The frame can preferably be pivoted around an angle from the prone position into the upright position. In particular, the frame can be pivoted around an angle of about 90°. This preferably involves the ability to pivot from a first, prone position, in which the net is arranged parallel to the loading floor, into a second, upright position, in which the net extends away from and projects over the loading floor.

In a particularly simple arrangement and mounting of the net relative to the frame, the net is mounted exclusively in frame sections that are spaced apart from each other and arranged parallel to each other. This represents a very simple mounting of the net in the frame.

A further development of the present disclosure provides that the net includes an elastic material. The net is thus kept flexible, so that it can also satisfy the purpose of holding or clamping one or several objects between the net, which is then expanded, and a structure of the passenger car. This is advantageous when arranging the frame in the prone position and fitting closely against the trunk floor. One or several objects can then be fixed between an expanded net and the trunk floor.

In addition, other objects, desirable features and characteristics will become apparent from the subsequent summary and detailed description, and the appended claims, taken in conjunction with the accompanying drawings and this background.

### BRIEF DESCRIPTION OF THE DRAWINGS

The present disclosure will hereinafter be described in conjunction with the following drawing figures, wherein like numerals denote like elements.

FIG. 1 is a view of a left trunk half of a passenger car configured as a station wagon with a fixture arranged near the loading edge for securing objects, for a first embodiment of the fixture in a vertical or upright position;

FIG. 2 is the fixture according to FIG. 1 for the right half of the trunk depicted on FIG. 1, but with the fixture in a horizontal or prone position;

FIG. 3 is an exemplary embodiment of a fixture, wherein a net of the fixture forms a flat surface,

FIG. 4 is another exemplary embodiment of a fixture, wherein the net forms two flat net sections arranged at an obtuse angle;

FIG. 5 for the exemplary embodiment according to FIG. 4 is a more detailed illustration of elements of the fixture for tensioning the net and mounts for securing a frame of the fixture in a structure of the passenger car;

FIG. 6 is a magnified view of the partial area outlined at VI on FIG. 5;

FIG. 7 is a vertical section through the fixture depicted in FIGS. 5 and 6, in the area of one of the two mount of the fixture;

FIG. 8 is a detailed view of an element for the fixture according to FIGS. 5 to 7 to tension the net in the two planes arranged at an obtuse angle to each other;

FIG. 9 is a partial view of the fixture shown in FIGS. 5 to 8 in which the fixture is in the prone position and the mounts are in a folded down position;

FIG. 10 is an exemplary embodiment of the fixture;

FIG. 11 is an exemplary embodiment of the fixture;

FIG. 12 is a modified exemplary embodiment of the frame and net;

FIG. 13 is a modified exemplary embodiment of the frame and net;

FIG. 14 is a modified exemplary embodiment of the frame and net, illustrated together with a partial area of a loading floor of the passenger car, depicted with the frame in a prone position; and

FIG. 15 is the arrangement according to FIG. 14 with the frame and the net in an upright position.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

FIG. 1 illustrates a passenger car 1 configured as a station wagon as viewed from behind in an open trunk 2 of the passenger car, visualized specifically for the left half of the passenger car 1. The right half of the trunk 2 is symmetrically identical in design to the depicted left half. A fixture 4 is secured in the trunk 2 to a loading floor 3 of the trunk 2, adjacent to the rear trunk opening. The fixture 4 is configured used to secure objects in the trunk 2. Shown is an object 5 arranged inside of the trunk 2, which in the example depicted is cylindrical in design, and stands on the loading floor 3 with its circular base area. The object 5 is arranged in front of and next to the fixture 4. The fixture 4 is also only illustrated for its left half. The right half is configured and positioned to mirror the left half of the fixture 4.

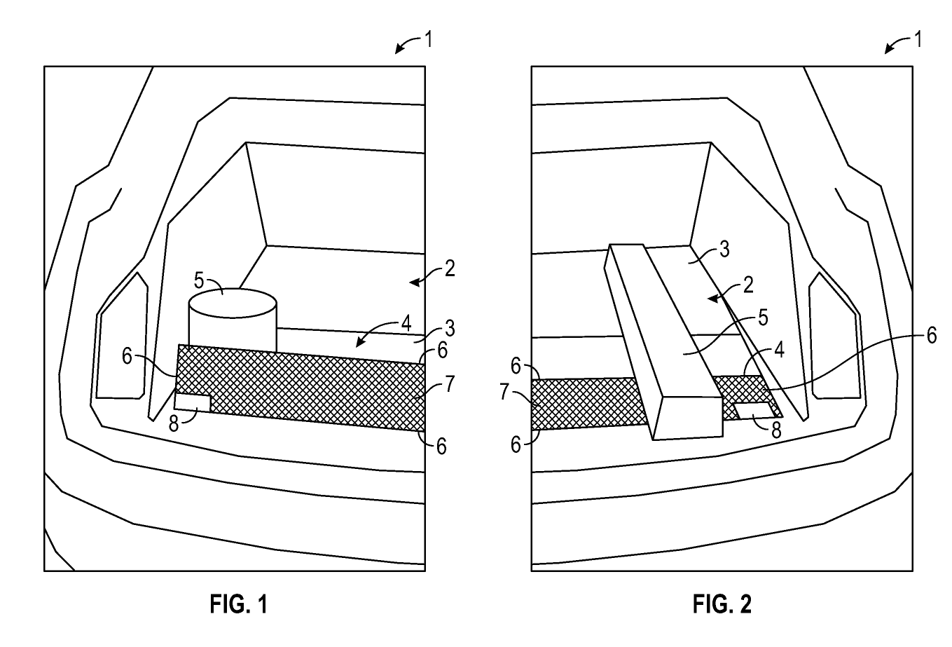

The fixture 4 has a frame 6, a net 7 mounted in the frame and flatly held by the frame 6, as well as mounts 8 for securing the frame 6 in a structure of the passenger car 2, for example the loading floor 3 as shown. In the exemplary embodiment, the mounts 8, which thus are arranged in the area of the left lower end and also the right lower end of the frame 6, are configured as hinges, so that the frame 6 mounted in the loading floor 3 can be moved between a vertical or upright position extending away from the loading floor 3 as illustrated in FIG. 1 into a horizontal or prone position forwardly pivoted by 90°, in which the frame 6 and the net 7 tensioned by the latter rest on the loading floor 3 as illustrated in FIG. 2. With continued reference to FIG. 2, the right half of the trunk 2 is shown. In this prone position, the entire length of the trunk 2 is available to be loaded with objects, wherein an oblong, box-shaped object 5 is shown resting on the frame 6 and net 7.

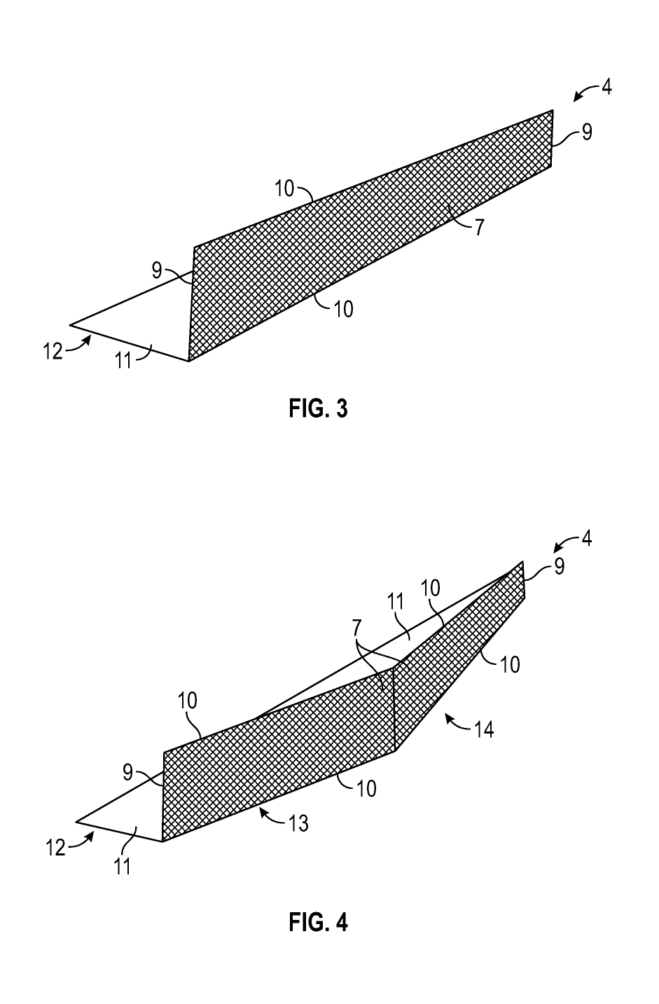

FIG. 3 presents a simple configuration of the fixture 4. It has a frame 6 with a flat structure. The frame 6 is rectangular in design, and thus arranged in a plane. In detail, the frame 6 has two short frame sections 9 and two long frame sections 10. The net 7 is accommodated between these frame sections 9, 10, and can have a tight-meshed or open-meshed configuration. As shown in FIG. 3, a plate 11 is arranged generally perpendicular to the frame 6, which is also rectangular in design, and in the area of a longitudinal side is fixedly connected with the frame 6 in the area of its lower frame section 10. The frame 6 and plate 11 can definitely form a rigid unit. As a consequence, it is not necessary that the frame 6 be able to pivot relative to the plate 11. In this case, the frame 6 cannot be switched into a prone position relative to the plate 11. The underside of the plate 11 is provided with a Velcro strip 12. In this regard, the plate 11 and Velcro strip 12 constitute the mount 8 of the fixture 4. Adjacent to the trunk opening, the loading floor 3 is provided with a material complementary to the Velcro strip 12, so that the fixture 4 can there be connected with the loading floor 3. If the fixture 4 is not needed, it only has to be detached from the loading floor 3 again.

FIG. 4 illustrates a variant in which the frame 6 is not flat in design, as a result of which the net 7 is not flatly tensioned. Rather, the frame sections 10 are each bent at an obtuse angle, so that the frame 6 tensions two planes 13, 14 for the net.

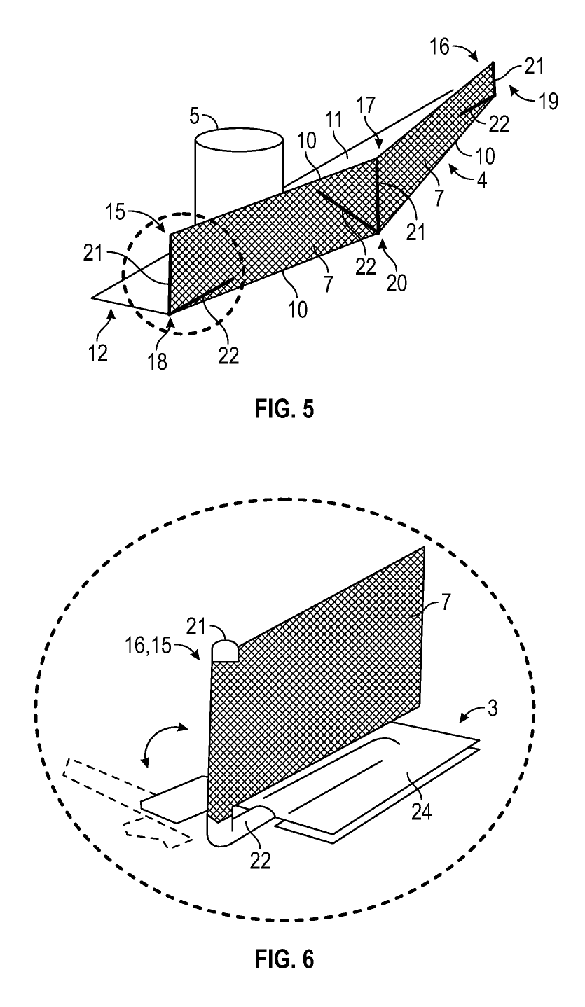

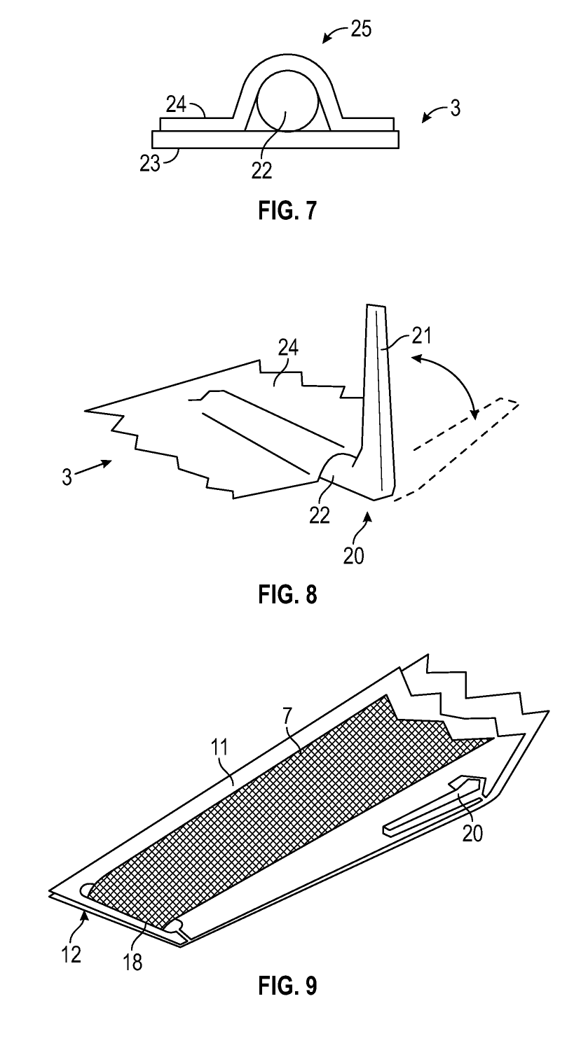

FIGS. 5 to 9 show an exemplary embodiment of the fixture 4 that is basically configured according to the exemplary embodiment as depicted on FIG. 4, but with the frame 6 pivotably mounted in the plate 11. The net 7 is here provided with three pockets 15, 16 and 17 arranged parallel to each other. The pockets 15 and 16 are formed in the area where the ends of the net 7 face away from each other, while the pocket 17 is formed in the area of half the longitudinal extension of the net 7. The respective pocket has introduced into it an angular section 18 or 19 or 20 of the frame 6 with a leg 21, while the other leg 22 is mounted in the loading floor 3. The legs 22 of the angular sections 18 and 19 can here be pivoted around the same axis, while the leg 22 of the angular section 20 can be pivoted around an axis that is vertical to this axis and runs through this axis. The angular sections 22 between components of the loading floor are pivotably mounted, for example a rigid plate 23 and a carpet 24 connected, for example adhesively bonded, to the latter, which has a bulge 25 between which and the plate 23 the leg 22 is pivotably mounted. Because the angular sections 18 and 19 can be pivoted in the area of their legs 22, the net 7 can be pivoted from the upright position illustrated on FIGS. 5 and 6 into the prone position according to FIG. 9. Beforehand, the net 7 in the area of its pocket 17 must be pulled off the leg 21 of the angular section 20, after which this angular section 20 is pivoted into the plane of the loading floor 3, as evident from the illustration on FIG. 8. It is here advantageous that the net 7 be elastic. This simplifies the process of moving the fixture 4 from its prone position into its upright position and vice versa on the one hand, and ensures that the net 7 is positioned tensioned parallel to the loading floor 3 in the prone position of the fixture 4 on the other.

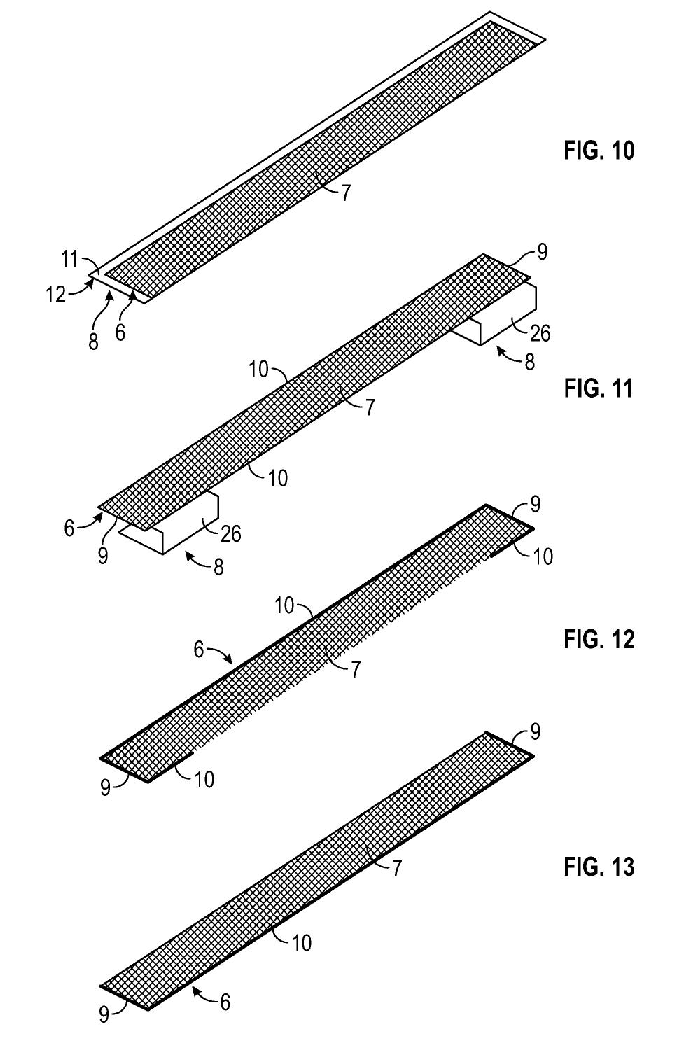

In the exemplary embodiment according to FIG. 10, the fixture 4 is fastened to the loading floor 3 with a Velcro mount. In this regard, the underside of the plate 11 is provided with the kind of connecting part that interacts with a carpet of the loading floor.

In the exemplary embodiment according to FIG. 11, the frame 6 and net 7 are fastened to the loading floor 3 with two thin clamps 26, which include the mount 8. These clamps have a U-shaped cross section, and can be simply plugged onto the end faces of a movable or pivotable loading floor 3, where they are positively or frictionally held. The frame 6 and net 7 can be rigidly or pivotably held in the clamps 26. The latter so that the frame 6 can be switched from the upright position into the prone position and vice versa.

FIG. 12 illustrates an alternative embodiment of the frame 6. This frame is not configured as a closed rectangle with the frame sections 9 and 10. Rather, the one frame section 10 is realized in the area of the frame sections 9, i.e., as a short attachment, which is used for mounting, in particular for pivotable mounting in the loading floor 3 or clamps 26.

In the exemplary embodiment according to FIG. 13, the frame is only included of a frame section 10, specifically the frame section 10 on the loading floor side, and the two other frame sections 9. The three frame sections thus form a pulled apart U.

In these described variants as well, the net 7 can easily be tensioned by the frame 6. In these embodiments, anywhere the net 7 faces frame sections 9 or 10, it is connected with the latter.

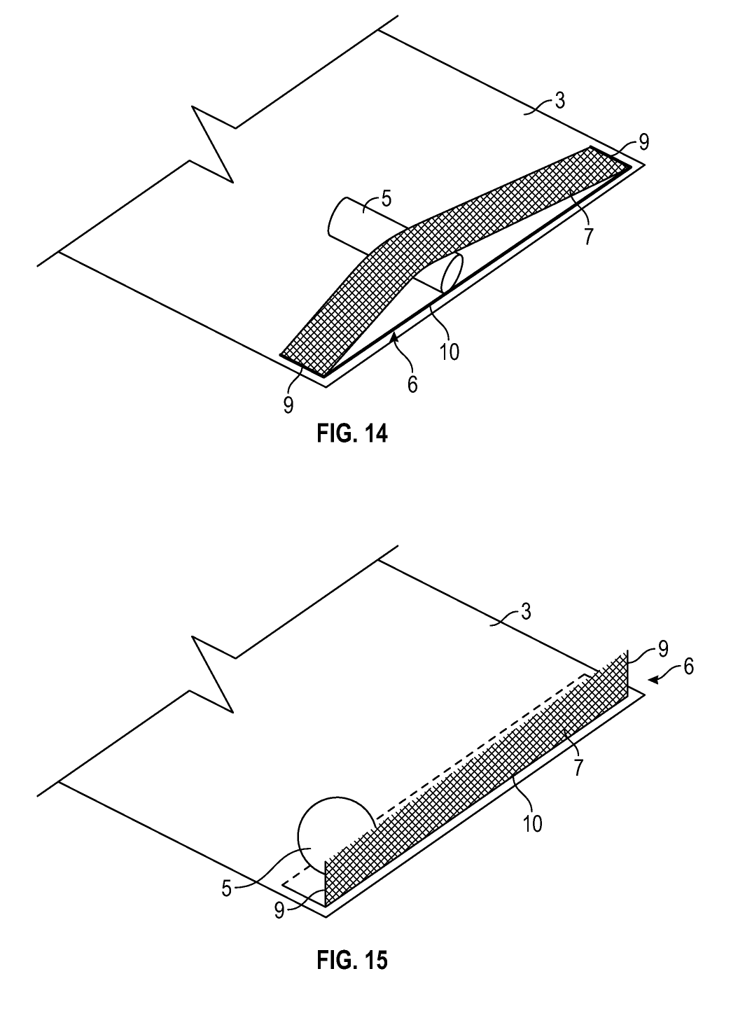

The exemplary embodiment according to FIG. 14 differs from the exemplary embodiment according to FIG. 13 in that the net 7 is only connected with the two frame sections 9 in the U-shaped frame 6. Otherwise, the net 7 is elastic in design. In the prone position of the fixture 4, in which the frame 6 is thus pivoted into the plane of the loading floor 3, an object 5 can be clamped under the net 7. For this exemplary embodiment according to FIG. 14, FIG. 15 shows the fixture 4 in its upright position. In this case, the net 7 tensioned between the two frame sections 9 is sufficient for preventing the illustrated spherical object 5 from rolling out of the trunk 2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-12. (canceled)

13. A fixture for securing objects in an interior of a vehicle comprising:
a frame including a first end member and a second end member spaced apart from the first end member, wherein the first and second end members have a flat cross-section;
a net mounted to the frame between the first and second end members; and
a mount configured to secure the frame to a structure in the interior of the vehicle.

14. The fixture according to claim 13, wherein the net is mounted to the frame to form a single planar panel.

15. The fixture according to claim 13, wherein the net is mounted to the frame to form a first planar panel and a second planar panel, wherein an obtuse angle is formed between the first and second planar panels.

16. The fixture according to claim 13, wherein the frame further a side frame member interconnecting the first and second end members to form a U-shaped frame.

17. The fixture according to claim 13, wherein the frame further comprises first and second side frame members interconnecting the first and second end members to form a rectangular frame.

18. The fixture according to claim 13, wherein the mount comprises a clamp cooperating with the frame for releasably securing the fixture to the structure.

19. The fixture according to claim 13, wherein the mount comprises a hinged connector configured to pivotally couple the fixture to the structure such that the frame and net are positionable between a first, upright position and a second, prone position.

20. The fixture according to claim 19, wherein the frame is pivotable from the prone position to the upright position through an angle of 90°.

21. The fixture according to claim 13, wherein the mount comprises a hook and loop fastener having a first strip secured to the frame and a second strip configured to be secured to the structure.

22. The fixture according to claim 13, wherein the mount comprises a plate secured to the frame.

23. The fixture according to claim 13, wherein the net is mounted exclusively between the first and second end members that are arranged parallel to each other.

24. The fixture according to claim 13, wherein the net comprises an elastic net that is at least partially stretched by the frame.

25. The fixture according to claim 13, further comprising a support having a first leg configured to be secured to the structure in the interior of the vehicle and a second leg extending perpendicularly from the first leg and engaging the net to form a first net panel and a second net panel, wherein an obtuse angle is formed between the first and second net panels.

26. A vehicle storage configuration comprising:
a vehicle interior having a trunk space with a loading floor;
a frame including a first end member and a second end member spaced apart from the first end member, wherein the first and second end members have a flat cross-section;
a net mounted to the frame between the first and second end members; and
a mount securing the frame to the loading floor.

27. The vehicle storage configuration according to claim 26, wherein the frame has a length corresponding to a width of the trunk space such that the fixture is configured to traverse the trunk space.

28. The vehicle storage configuration according to claim 26, wherein the mount comprises a clamp cooperating with the frame to releasably secure the fixture to the loading floor.

29. The vehicle storage configuration according to claim 26, wherein the mount comprises a hinged connector pivotally coupling the fixture to the loading floor such that the frame and net are positionable between a first, upright position and a second, prone position.

30. The vehicle storage configuration according to claim 26, wherein the mount comprises a hook and loop fastener having a first strip secured to the frame and a second strip secured to the loading floor.

31. The vehicle storage configuration according to claim 26, wherein the mount comprises a plate secured to the frame and supported on the loading floor.

32. vehicle storage configuration according to claim 26, further comprising a support having a first leg secured to the loading floor and a second leg extending perpendicularly from the first leg and engaging the net to form a first net panel and a second net panel, wherein an obtuse angle is formed between the first and second net panels.
